(19) United States
(12) Patent Application Publication
(10) Pub. No.: US 2011/0159250 A1
(43) Pub. Date: Jun. 30, 2011

(54) PATTERNING METHOD

(75) Inventors: Christopher B. Rider, Cambridge (GB); Andrew Clarke, Cambridge (GB)

(73) Assignee: EASTMAN KODAK COMPANY, Rochester, NY (US)

(21) Appl. No.: 12/674,442

(22) PCT Filed: Aug. 14, 2008
(86) PCT No.: PCT/GB2008/002736

§ 371 Date: Feb. 22, 2010

(30) Foreign Application Priority Data
Sep. 1, 2007 (GB) 0717054.1

(51) Int. Cl. B32B 3/10; B05D 5/00; B05D 1/00; B05D 5/12

(52) U.S. Cl. 428/195.1; 427/256; 427/58; 427/98.4

(57) ABSTRACT

The invention provides a method of patterning flowable material on a surface. The method comprises providing the surface with at least one channel and at least one deposition region connected to the at least one channel, the width of the channel being less than the width of the deposition region, and depositing flowable material in the deposition region such that when the material makes contact with the channel the material is directed into said channel by capillary forces, the receding contact angle of the flowable material in the deposition region being less than 30°.

### FIELD OF THE INVENTION

The invention relates to a patterning method and in particular to a method of patterning a surface in the manufacture of electronic, optical and optoelectronic devices. The invention also relates to devices manufactured by the method.

### BACKGROUND OF THE INVENTION

The development of silicon-based thin-film transistor (TFT) technology has been an essential enabler for the development of large flat panel displays. Despite the huge cost of factories to manufacture TFTs on glass and the complexity of the TFT manufacturing process, the technology is now well-established for active matrix liquid crystal displays and is based largely on photolithographic techniques for depositing patterns of the various materials into multilayer structures.

In recent years great progress has been made on TFT technologies based on other semiconductors including polymers, metal oxides and semiconducting nanowires and nanotubes. Many of these approaches benefit from simpler processes that promise greatly reduced commercialisation investment compared to the current silicon-based factories. Another recent development has seen liquid processed semiconductors deposited onto flexible substrates using additive approaches such as inkjet and conventional printing and this promises further process simplification and cost-reduction as more processes can be performed in roll-to-roll configurations.

These new approaches to the production of TFTs can also be applied to the production of other optoelectronic devices such as photovoltaics, photodetector arrays for scanning applications or image capture and organic light emitting diode arrays for electronic displays or sensors.

A common need for all thin film optoelectronic devices, especially arrayed structures such as displays or scanners, is the provision of conductive bus lines and electrodes. In a display, for example, data bus lines connect pixel electrodes together in rows and columns. Other bus lines provide power to the pixels. It is important that the bus lines should be highly conductive so that resistive losses are minimised and device non-uniformities are avoided. Usually, the requirements for the conductivity of the pixel TFT electrodes are not so severe as for the bus lines, but the need for high resolution electrode patterning is more important. It is preferred that TFT gate electrodes should not overlap substantially with the source and drain electrodes to minimise parasitic capacitance. Gate electrode widths below 10 microns are not uncommon and with the drive to increase switching speeds and reduce TFT footprint within the pixel area, there is a need to further reduce all the dimensions of the TFT.

When fabricating a multi-layer TFT device, accurate registration between the features in all the layers is very important if optimum device performance is to be achieved. Certain features, however, require greater alignment accuracy than others. Alignment of the gate electrode with the channel region of a TFT formed between the source and drain electrodes is very important and overlap between the gap and source and drain electrodes is to be avoided. On the other hand, the semiconductor and dielectric layers may significantly overlap the device electrodes without detriment to performance, provided that adequate isolation is achieved between neighbouring TFTs and between neighbouring pixels so that leakage currents do not cause inter-pixel cross-talk. Thus, some features of a TFT require accurate and high-resolution pattern registration, while others do not.

During a TFT manufacturing process many separate steps are typically required. Between each step and even during a step, environmental conditions such as ambient temperature and, humidity may change, causing changes in dimensions of the carrier substrate for the TFTs and of masks or positioning equipment for deposition or patterning tools. Thus registration errors may accumulate between TFT layers. The temperature of the substrate and deposition or patterning tools may also change during an individual process step as sources of heat are frequently necessary for deposition, patterning or post deposition treatments. These temperature changes also cause dimensional changes within a single patterned layer and again registration may be affected. There is therefore a need to accurately control registration and alignment as well as the dimensions of individual patterns throughout the manufacturing process of thin film optoelectronic devices in general.

Another important issue to be considered is the efficient use of materials. In the well-known photolithographic process used for semiconductor device manufacture, materials are deposited over the whole device substrate and removed pattern-wise. This subtractive approach, while highly reliable and accurate, is wasteful of materials. It is preferable where possible to use additive processes in which materials are only deposited where they are required. In recent years, ink-jet deposition has been widely used to place small droplets of material onto surfaces. This technique enables significant reduction in material wastage because it is an additive process.

For large feature sizes, additive processes offer great promise as patterned deposition technologies. For small feature sizes, however, additive processes, such as conventional printing and inkjet have more limited applicability. Inkjet droplet sizes are typically of the order of a few picolitres. A 1 pl droplet has an in-flight diameter of 12 microns. When it lands it spreads and depending on the surface energy of the substrate and the surface tension of the liquid, the diameter of the circle that is now covered with liquid could be much larger than the diameter of the original droplet. This significantly limits the resolution of patterning that can be achieved. Furthermore, there is a limit to the accuracy with which inkjet droplets can be placed at a precise location on a surface.

Many approaches have been suggested to reduce the pattern resolution limitations arising from inkjet droplet sizes. US 2005/0170550 describes the use of banks of appropriate wettability formed on a surface to contain liquid droplets that are incident on the surface between a pair of banks. The process for forming the banks and for profiling the wettability of the sides requires several steps. U.S. Pat. No. 7,115,507 describes a method of restricting the lateral spreading of a liquid droplet on a surface by the use of indent regions.

When making electronic devices such as TFTs using largely solution-based deposition processes, there have been many approaches to overcome the problem of aligning the gate electrode with the semiconductor channel region. WO 03/034130 describes a method of using the topology of a liquid film while it is still wet to align a second liquid, immiscible with the first, deposited on top of it. US 2005/0071969 describes a method of embossing a groove and building an electronic device in the groove. WO 2004/055920 describes a method for making electronic devices in which a surface topology is defined in a lower layer, preferably by embossing, and a non-planarising upper layer is deposited such that liquid applied to the upper layer conforms to the topology defined originally in the lower layer. Various methods of constructing TFTs are proposed but these require many extra process steps to manipulate the wettability of surfaces and to achieve alignment of the gate and the TFT semiconductor channel. A further difficulty is the use of raised topologies in some embodiments which suffer greatly reduced capillary flow speed's due to the convex profile of the surface of the liquid as it flows along the channel.

Managing the flow of liquid on the surface of the substrate on which the electronic devices are fabricated is a key issue, especially given the need to reduce processing time to a minimum so that fabrication costs are low. Care must be taken to avoid droplets of functional material both bridging between two wettable features closely spaced on a surface and creating voids within a feature which become defects. US 2006/0091547 describes a method for providing a linear region and a wider region both enclosed by banks, such that the thickness of the dried film formed after jetting droplets into the region between the banks is substantially uniform. US 2005/0005799 describes a method for jetting a series of spaced droplets into a long narrow lyophilic channel so that the droplets do not wet the top surfaces of the channel but flow off them into the channel. The spacing between neighbouring droplets is such that they fill the channel and merge with one another to form a continuous strip of liquid. No liquid remains on top of the channel walls, even if the original incidence of the droplet was partly on the top as well as the walls of the channel. In this method, adjacent channels must have a lyophobic surface between them that is wider than the droplet width on impact to ensure that any droplet never bridges the gap between two adjacent channels. This limits the closest approach between neighbouring channels. Furthermore, it is generally much harder to get good adhesion between a lyophobic surface and a layer that is deposited on top of it. This can lead to mechanical weakness in multilayer devices of the kind addressed by the present invention.

### PROBLEM TO BE SOLVED BY THE INVENTION

Each of the prior art documents address several but not all of the problems simultaneously. There is also little discussion of the problems of overfilling channels wherein functional liquids can flow uncontrolled across a surface. It is the object of the present invention to provide a self-aligning method for fabricating electronic devices by additive liquid deposition techniques offering the patterning of very fine features and gaps between features and substantially avoiding defects due to open-circuits, short-circuits and mechanical failure between layers.

### SUMMARY OF THE INVENTION

According to the present invention there is provided a method of patterning flowable material on a surface, the method comprising providing the surface with at least one channel and at least one deposition region connected to the at least one channel, the width of the channel being less than the width of the deposition region, and depositing flowable material in the deposition region such that when the material makes contact with the channel the material is directed into said channel by capillary forces, the receding contact angle of the flowable material in the deposition region being less than 30°.

The channel regions may be defined as a concave region through embossing.

### ADVANTAGEOUS EFFECT OF THE INVENTION

The method of the invention is self-aligning. It is insensitive to substrate distortion and very accurately aligns, for example, the gate electrode of a TFT to the semiconductor channel region between the source and drain electrodes with no overlap. This reduces parasitic capacitance and improves device speed.

The invention allows the distance between the source and drain electrodes (i.e. the semiconductor channel length) to be reduced substantially below printing resolutions. It enables gaps to be brought much closer with respect to the width of an inkjet droplet. Bringing the lines closer together reduces TFT conduction path length thus increasing switching speeds and reducing the device footprint.

The method of the invention also increases the speed of forming the patterns. It is possible to deposit a functional fluid into a well or deposition region and have the patterns form by virtue of capillary flow whilst the deposition head is being moved to the next well. It is not necessary to actually deposit fluid at all points the fluid is required.

The invention provides better adhesion of overlayers to the substrate since it does not have to have a lyophobic characteristic on the areas where the flowable material should not flow. There is no possibility for the deposition region to empty and create open circuits. There is no possibility for the channel to overflow and create short circuits. The closest approach of two channels can be much closer because there is no need to have a large lyophobic land between the channels.

The invention also allows the pre-patterning step to be simplified. There is no requirement for, for example, the formation of banks or areas of surface energy contrast. In the preferred embodiment channels are defined as recessed regions in the surface and may be formed for example by photolithography, embossing, laser ablation, cutting and moulding. In a further preferred embodiment, embossing alone is enough to prepare the substrate for patterning. Embossing is a low cost technique and may be done roll-to-roll so that incremental costs in preparing the substrate for deposition are minimised versus some of the other routes.

The method of the invention may be readily used to pattern functional materials to achieve feature sizes of 100 nm. With great care and careful selection of materials it is possible to make patterns by the method with feature sizes of a few tens of nanometres. The method enables very high resolution features to be made and is therefore applicable to the manufacture of frequency selective surfaces, metamaterials, as well as all kinds of electronic devices and optoelectronic devices. The method of the invention may also be used to pattern biological materials and to make sensor arrays.

The method is insensitive to drop volume variations. The surface has appropriate surface energy to enhance adhesion. Corona discharge treatment (CDT) can be used to provide further adhesion and zero receding contact angle.

### BRIEF DESCRIPTION OF THE DRAWINGS

The invention will now be described by way of example with reference to the following drawings in which:

FIGS. 1a to 1j illustrate various channel geometries defined by a physical structure;

FIG. 2 illustrates an embodiment in which the deposition region forms bus lines after patterning;

FIG. 3 illustrates the channel structure used in Example 1;

FIGS. 4a and 4b illustrate the channel structure used in Example 2 and the results produced;

FIG. 5 illustrates the definition of channel angle and a condition for capillary flow; and

FIG. 6 illustrates the definition of the widths of the deposition region and the channel.

### DETAILED DESCRIPTION OF THE INVENTION

The present invention provides an improved method for manufacturing electronic and optoelectronic devices. Devices manufactured by the present invention are described in co-pending application docket no 94260, “An Electronic Device”, filed on the same day as the present application.

The present invention provides a deposition region on the substrate on which an electronic device is to be fabricated. The functional liquid is supplied to this region by any convenient method such as by ink-jet printing. The invention is not however limited to this additive method. It will be understood by those skilled in the art that any suitable printing method may be used such as by conventional printing, e.g. lithographic printing, flexographic printing, screen printing, pad printing, gravure printing, intaglio printing and also by digital printing techniques such as electrophotographic printing. Fine channels connect to the deposition region. When liquid in the deposition region comes into contact with a channel, liquid is directed along the channel by capillary wicking. The liquid will continue to flow into the channel from the deposition region, until either it reaches the end of the channel or until the volume of liquid in the deposition region is reduced to the point that the pressures of the liquid in the deposition region and the channel region are equal. The deposition region may be constrained by boundaries, such as banks, surface energy contrast, or a recessed region or it may be entirely or partially undefined on the surface of the substrate. Furthermore, deposition regions may overlap so that when material is deposited in such overlapping deposition regions a continuous pattern is formed.

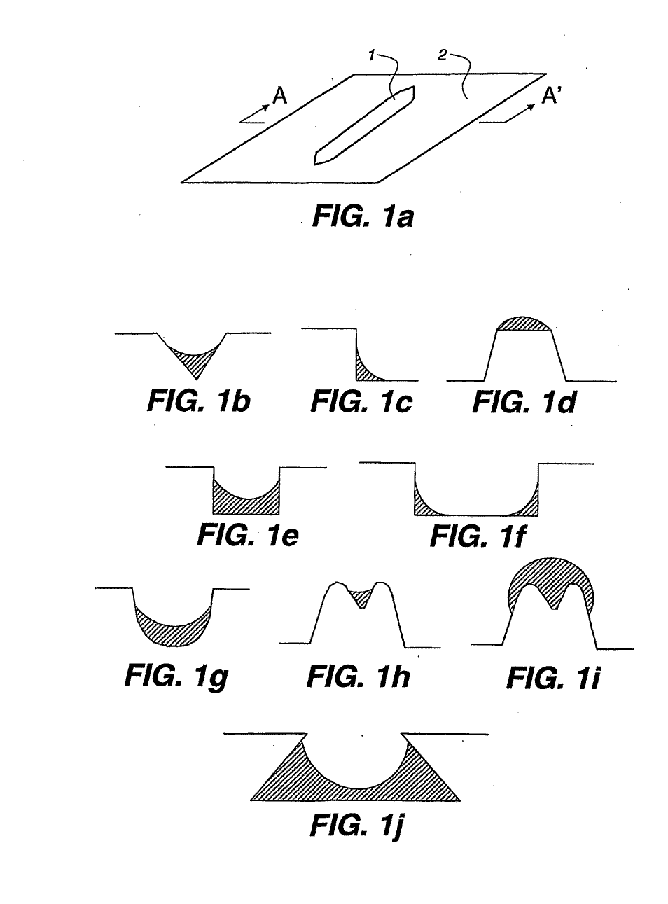

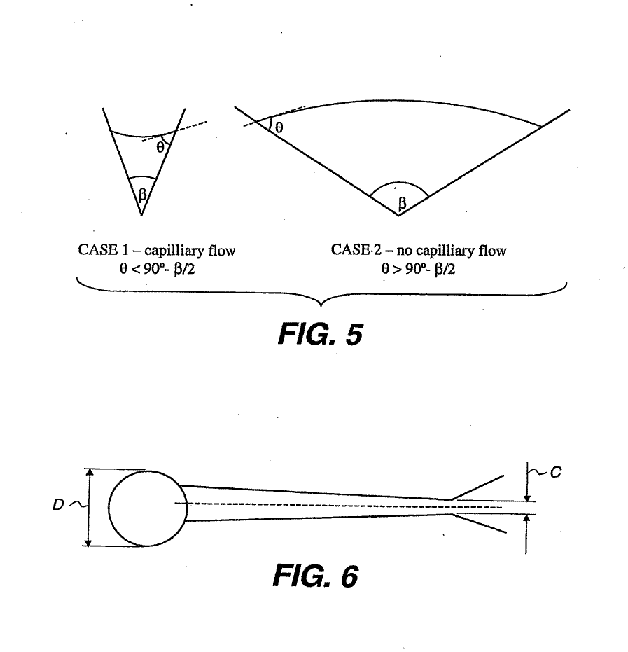

“Channel” 1, as illustrated in FIG. 1a includes any linearly extended topology on a substrate surface 2 that confines liquid by means of capillary force. It includes, but is not limited to, recessed areas, raised “lands” bound by sharp-edged descending walls and steps where the flowable material is confined to and directed along the base of the step. Channel topology may be characterised either as convex or concave by which is meant that a channel can be said to be concave if the liquid is confined within the channel structure. A convex channel is one in which the liquid is confined outside the channel structure. A flat surface, which is by definition neither convex nor concave, cannot confine liquid by surface topology and liquid placed on a flat surface spreads freely until the contact angle at the wetting line is less than the advancing contact angle. FIG. 5 defines the channel angle β for a V groove channel. Note that the channel angle is defined by the intercept of the projection of the side walls at the wetting lines, rather than the actual shape of the base of the channel, although in the case of FIG. 5 the two are the same.

FIG. 1b illustrates a V groove channel with a channel angle of just less than 90° showing liquid confined within the channel. This channel geometry is concave. FIG. 1c illustrates a channel with a channel angle of 90° configured as a step. Liquid is confined at the base of the step. Capillary forces are much stronger than gravitational forces over distances less than the capillary length (typically a few millimetres) and so the orientation of the channel in space is irrelevant. Liquid would be confined in the V groove of FIG. 1b or the step of FIG. 1c whether or not the substrate was orientated upwards or downwards. Therefore the structures illustrated in FIGS. 1b and 1c are almost identical in terms of their confinement efficiency. A difference would arise if the channel in FIG. 1b were filled to the top, at which point the liquid would pin on the topological discontinuities on either side of the channel. In the case of FIG. 1c, there is a discontinuity to the left hand side of the channel that would act as a pinning point, but such a discontinuity is not shown on the right hand side and so liquid would not be confined and would be free to flow until the advancing contact angle is reached.

FIG. 1d is an example of a convex channel with a channel angle of 180°. Liquid is contained on the outside of the channel structure. In fact, the flat land on the top of the protrusion does not contain the liquid in the same way as the channels of FIGS. 1b and 1c where capillary interactions with the walls and the nature of the wall geometry contain the liquid. In FIG. 1d, it is only the discontinuities at either side of the flat land that pin the wetting line and confine the liquid. If a small droplet of liquid were placed on the flat land and allowed to spread, it would do so freely as on a flat surface, without the enhancement that comes from interaction between the wetting line at its leading edge and the surface profile at the base of a V groove channel.

FIG. 1e shows a rectangular channel, also an example of a concave channel, with a channel angle of 0° since the planes of the channel walls where the wetting lines on either side of the channel are situated do not intersect. FIG. 1f illustrates another much wider rectangular channel in which the volume of liquid contained is not enough to wet the whole of the bottom of the channel. The channel therefore behaves as two step channels as shown in FIG. 1c that do not communicate with each other. FIG. 1f is therefore illustrating two concave channels with channel angles of 90°. It is noted that within a rectangular channel such as 1e and 1f, it is possible to have liquid at the leading edge of the capillary flow filling the channel as illustrated in FIG. 1f whereas further back from the leading edge, where the channel has a higher volume of liquid contained within it, it may fill the channel as illustrated in FIG. 1e.

It is not necessary to have sharp geometries to confine liquid as shown in FIGS. 1g and 1h, which are both examples of concave geometries with channel angles of approximately 10° and 60° respectively. The channel of FIG. 1i, however, despite having the same topology as the channel of FIG. 1h has a greater volume of liquid being confined such that the inner channel shape cannot contain all the liquid. The channel angle is now approximately 325°. Liquid is still confined, but the confinement of the wetting line is now on the outside of the structure and this is therefore an example of a convex channel. It will be recognised that the geometry of FIG. 1i is highly unstable and there is a significant risk that the liquid will run down the walls of the channel at the slightest pertubation. FIGS. 1h and 1i illustrate that it is sometimes not possible to define a channel as concave or convex simply by its topology as the position of the wetting lines are needed to understand the nature of the confinement. For the sake of clarity, in FIG. 1i, had only one side of the inner channel overflowed so that only one of the wetting lines had been situated on the outside of the structure, it would still be functionally a convex channel. It is necessary for both the wetting lines to be on the inside of the structure for it to be defined as concave.

FIG. 1j is another example of a concave structure but with a channel angle of −90°. Channels with a negative channel angle are narrower at their upper opening than at their base. Although this structure is very effective at wicking liquid and confining it, owing to difficulties in manufacture of such structures by low cost processes, it is not a preferred embodiment.

Channels of the present invention are concave, by which is meant that they have a channel angle, β, greater than −180° and less than 180°. More preferably channel angles of the present invention are greater than −150° and less than 150°, such that the capillary enhancement to the flow of the functional material in the channel is more significant. Most preferably the channel angles are greater than 0° (for ease of manufacture of the channel by stamping or embossing) and less than 90° to further enhance capillary wicking and widen the range of functional materials that can be used. It is not necessary for channels of the present invention to have sharp-edged pinning points defining the boundaries of the channel and preventing overflow, but channels with preferred topologies have at least one sharp-edge pinning point and preferably two.

Flowable material is deposited in the deposition region, which is of larger maximum extent than the channel width to facilitate correct location of the flowable material, given that positioning tolerances of the deposition technique and the extent of the minimum volume of material that may be deposited may be much larger than the dimensions of the channel. The deposition method may be any printing method, including but not limited to inkjet, electrophotographic methods, flexography, gravure, screen printing and offset lithography. It is understood that the viscosity of the deposited material may be reduced to make the material more flowable after deposition by a further treatment step, such as raising the temperature. In a preferred embodiment the channel width is less than the resolution of the deposition method. All printing methods routinely achieve resolutions of 100 microns, but below this value, accurate definition of features becomes increasingly difficult. Screen printing for example, struggles to achieve gaps between features below 50 microns. Typical inkjet resolutions are limited by the width of the droplet after impact with the surface and typically achieve a minimum feature size of 40 microns. Offset lithography and gravure printing can achieve feature sizes of 30 microns when extremely well controlled. No conventional printing technique can achieve feature sizes and gaps between features of 10 microns that would be in the preferred dimension range for construction of TFT features.

It will be recognised, as illustrated in FIG. 6, showing a plan view of a channel and deposition region, that the width of the deposition region, being defined as the maximum extent of the deposition region, D, as measured in any direction in the plane of the substrate will be significantly larger than the width of the channel, C, where width of the channel is measured across the channel at its widest transverse dimension—i.e. the width at the “top” of the channel (in the case of a concave channel)—measured in a direction perpendicular to its length in the plane of the substrate at the narrowest point in the channel. Therefore, should the channel width vary along its length, the channel width should be measured at its narrowest point, C, as illustrated in FIG. 6.

The flowable material may include conductive, semi-conducting, light emissive, light reflecting or dielectric inks. The flowable material may comprise precursor materials, or catalysts that may enable functional material to be formed within the channels by a subsequent process. The flowable material may comprise a carrier solution with particles dispersed therein. The particles may be biological materials, high molecular weight molecules, viruses, cells, bacteria, nanoparticles, quantum dots and polymer particles. Flowable material also includes materials that are deposited in the deposition region in solid or highly viscous form, but which on heating become flowable and are able to move rapidly under the action of capillary forces. Solders and phase-change inks are examples of materials that become flowable when heated. It will be understood that these are examples only and the invention is not limited to these examples. Once the flowable material has been deposited in the deposition region, it spreads out until the wetting line contacts the channel region at which point liquid from the deposition region flows into the channel region and wicks along the channel by capillary forces.

When considering wetting behaviour of surfaces, conventionally an advancing contact angle is defined. If a sessile drop is formed and liquid added slowly, then the advancing angle is defined as the angle between the tangent of the liquid surface and the substrate measured at the three-phase line and through the liquid as the line just begins to advance. For more information on this topic see for example “Capillarity and Wetting Phenomena” by Gilles De-Gennes, Brochard-Wyart and Quere published by Springer 2003. Likewise, the receding contact angle can also be defined. If a sessile drop is formed and liquid removed slowly from the drop, then the receding contact angle is defined as the angle between the tangent of the liquid surface and the substrate measured at the three-phase line and through the liquid as the line just begins to recede. If the wetting line does not recede the contact angle is defined as zero degrees. A low receding contact angle can be created by roughening the substrate or by chemical treatment such as corona discharge treatment or a non-planarising layer with an intrinsically low receding contact angle. Wetting hysteresis is defined as the difference between the advancing and receding angles. A surface is termed reversible if it has zero wetting hysteresis. The rate of wicking along the channel may be controlled by the channel angle, β, defined in FIG. 5.

The greater the channel angle, the slower the rate of wicking will be. When the advancing contact angle, θₐ, is less than (90°−β/2) wicking will occur as described in “Flow of simple liquids down narrow V grooves”, Mann et al., Phys. Rev.E. 52, p 3967, 2005. Preferably, θₐ should be set somewhat below this value to facilitate rapid wicking along the channel and thus minimise evaporation losses from the liquid which may change its flow characteristics as it wicks.

The present invention is particularly suited to the forming of patterns for electronically active structures. Not only may the channel regions be used to form circuit elements such as TFTs, but the deposition regions may form circuit elements of larger dimension also. Examples of such circuit elements are conductive bus lines, capacitors, inductors and resistors.

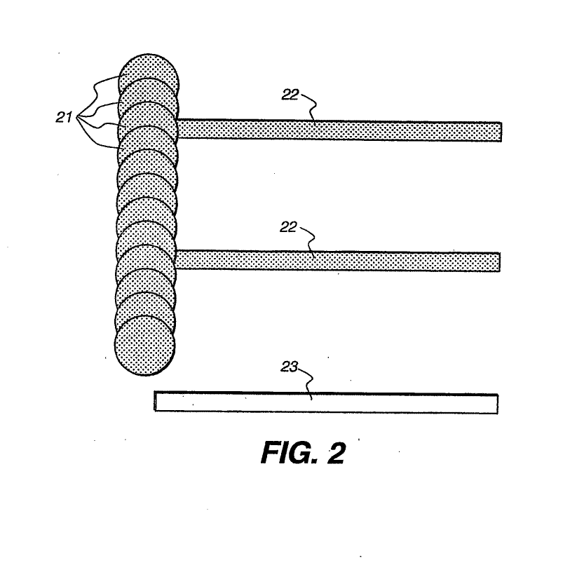

In one embodiment of the present invention, the flowable material is a conductive ink and the channels direct the material to the electrodes of an electronic device such as a TFT. In this embodiment, it is preferable that the deposition region is part of the bus lines that form the data and select lines or that provide the power and ground to the device, as shown in FIG. 2. In this example, flowable material, a conductive ink, was deposited by inkjet, such that each droplet of ink is positioned to overlap with the previously deposited droplets 21. Channels 23 are provided in the surface as recesses such that when the deposited droplets of ink make contact with the channels, ink is directed along the channels 22 by capillary forces. The deposition regions of each channel are here undefined by physical or chemical patterning and allowed to connect to each to form a continuously conductive structure which may be used as a highly conductive line, such as a bus line for power or data or data select functions for several devices. The smaller channels connect to devices (not shown) on another part of the substrate. In this case it is essential to avoid open circuits. In certain circumstances it is possible for a droplet of material deposited in the deposition region to be entirely drawn into the channel region, thus emptying the deposition region and leading to a gap in a bus line. The movement of flowable material into the channel stops when either the pressure in the flowable material body is everywhere the same, or when the flowable material solidifies. Thus provided the deposition region has a non-zero receding contact angle and the channel volume is greater than the volume of the body of flowable material, then the equalisation of pressure implies that the flowable material will continue to move until it has been drawn completely into the channel. The present invention avoids this undesirable situation by arranging the liquid flow to prevent this. This is achieved by ensuring a receding contact angle of less than 30°, preferably less than 15°, at least within the deposition region but possibly over the entire surface. Even more preferably the receding contact angle is less than 5°, or zero. Note that this constraint also ensures good adhesion for the added layer.

In the present invention, liquid flow is further arranged such that the channel cannot overflow and cause undesirable bridging between circuit elements. This may be achieved by setting a further condition on the receding contact angle, θᵣ. The flowable material will continue to flow until the pressure in the liquid body is everywhere equal, or until the material solidifies. Given the small scale of the structures under consideration here (i.e. much smaller than a capillary length) and the low Reynolds number of the flow the local pressure is entirely determined by the Laplace pressure, i.e. the ratio of surface tension and local surface curvature. The nature of capillary wicking, i.e. flow into the channels, is such that at the advancing front there has to be a concave surface with radius of curvature of order {cos(contact angle)/channel dimension}, whereas the deposition region has a curvature of order {cos(contact angle)/source dimension}. If the deposition region has a non-zero receding contact angle and the channel has a volume greater than the flowable material body, then as the flowable material is drawn into the channel the volume of liquid in the deposition region drops and its radius of curvature drops. If either the channel volume is too small, or the viscous pressure drop along the channel is high, then as the radius of curvature falls, the pressure in the deposition region may be sufficient to cause a quantity of flowable material to be expelled from the channel. These conditions are specific, and can be avoided under all situations if the deposition region has a zero receding contact angle. For defined situations created by a particular embodiment, this condition can be relaxed to a requirement of a minimum level of contact angle hysteresis.

In another embodiment material is deposited in the deposition region, but does not flow into the channel region. Energy is applied to the material such that the material becomes flowable. Materials that display this property would include phase change inks, which can change viscosity by several orders of magnitude when the temperature is increased beyond a certain critical temperature. Another material that displays this property would be a material that melts above a certain temperature, such as, for example, solders and waxes. Once the viscosity has dropped, the material may flow and is able to be directed into the channel by capillary wicking from the deposition area. After the material has flowed down the channel the viscosity again returns to its normal ambient state as the material cools. The benefit of this approach is that very low-cost patterned deposition methods such as offset lithographic printing or flexographic printing may be used to achieve coarse positioning of a material on the surface of a patterned substrate. Fine positioning is achieved by capillary wicking after a change in material viscosity is achieved.

The present invention offers a method for making patterns of any flowable material, including liquids containing dispersions of solid particles. The liquid may contain at least one of a polymer, a monomer, a high molecular weight molecule, a latex, a solid particle, an emulsion, a reactive species, and/or a soluble metal complex. It is particularly suited to making patterns of conductive materials for connections between devices and for definition of electrode structures in optoelectronic thin film devices. The method can work on any surface on which is defined a channel. The method can be used to fabricate antennae, interconnectors, bus lines, optoelectronic devices, and in particular, TFTs.

Devices fabricated as described above may be part of a more complex device or product in which one or more of the devices may be integrated with each other or with other devices. Examples include but are not limited to displays, RFIDs, touch screens and batteries.

### EXAMPLE 1

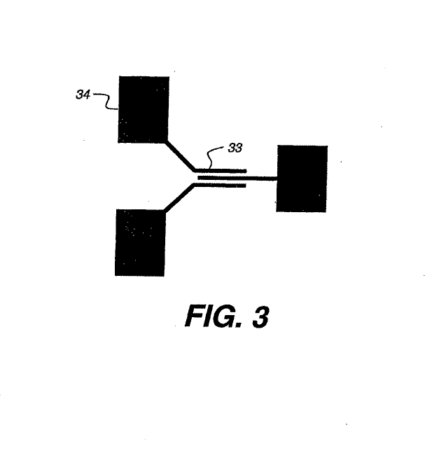

In FIG. 3 the black areas are channels 33 created in photoresist, with a width of 50-200 micrometers and a depth of 50 micrometers. The large black squares are the ‘deposition regions’ 34 into which the functional liquid is deposited by ink jet. Capillary forces then cause the liquid to flow into the channels.

The behaviour of the liquid is determined by the contact angle between the liquid and the substrate in which the channels are fabricated. Two angles are of importance here; the advancing angle, which determines whether the liquid will wet the substrate and be drawn into the channel, and the receding angle, which determines whether the substrate will remain wetted by the liquid, or if the liquid will de-wet. This is important if a design such as that shown in FIG. 3 is used to create conductive pads for an electrical device. Ideally one would like the ‘deposition regions’ (black squares) to remain wetted by the liquid, to allow for subsequent electrical connection to these areas.

A liquid will only be drawn off a surface when the contact angle falls below the receding angle. Therefore if the surface has a low, or preferably zero, receding contact angle, the liquid will remain pinned on the substrate and will not de-wet. Conversely if the receding angle is close to the advancing angle, it is likely that the liquid will de-wet.

### EXAMPLE 2

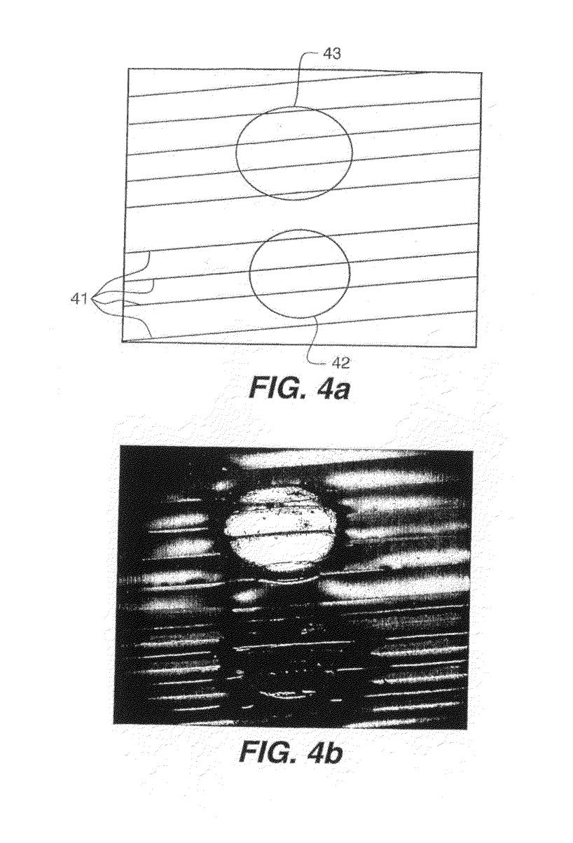

In this example V shaped grooves in polycarbonate (3M optical lighting film, SOLF™) were used as the substrate material as shown in FIG. 4. FIG. 4a shows schematically the apex of each groove 41 and two deposition regions 42 and 43 defined in the substrate. The untreated polycarbonate material has an advancing contact angle of ˜70 deg. and a receding angle of ˜65 deg. with water. The high advancing angle causes the water to not freely wet the polycarbonate, and so it was not drawn along the grooves.

The test liquid used was a non-drying ink used as a model fluid with constituents;

### Water+

Diethylene glycol—14-22%
Black colourant 13-14%
Butoxy tri glycol 10%

### Urea 3-6%

### Triethanolamine 1-3%

The solution as used had a viscosity of a few cP and a surface tension of approximately 30 mNm−1.

The advancing contact angle and receding contact angle of the test liquid on the polycarbonate substrate were both approximately 30 degrees. It was found that the liquid would wick along the v-groove channels freely, but would also dewet cleanly.

Several deposition regions were created in the V-groove film by lightly pressing a soldering iron tip set at 130° C. into the substrate to create wells measuring approximately 600×200×3000 microns.

To modify the receding angle of the polycarbonate, some of the two deposition regions 42 were coated in a 0.5% w/w aqueous gelatin solution and then dried. The receding angle for most aqueous based liquids on a gelatine surface is very low or zero, which causes spread liquids to pin and not de-wet.

The modified and unmodified wells were filled with a small volume, measuring approximately 1 microlitre, of the model ink either by micro-pipette using Drummond microcaps, or by inkjet deposition using a Dimatix DMP 2800 printer.

It was found that the unmodified wells 43 in all cases emptied of ink as it was drawn into the narrow channels whereas the modified wells 42 retained a film of the ink.

The invention has been described in detail with reference to preferred embodiments thereof. It will be understood by those skilled in the art that variations and modifications can be effected within the scope of the invention.

1. A method of patterning flowable material on a surface, the method comprising providing the surface with at least one channel and at least one deposition region connected to the at least one channel, the width of the channel being less than the width of the deposition region, and depositing flowable material in the deposition region such that when the material makes contact with the channel the material is directed into said channel by capillary forces, the receding contact angle of the flowable material in the deposition region being less than 30°.

2. A method as claimed in claim 1 wherein the receding contact angle is less than 15 degrees.

3. A method as claimed in claim 2 wherein the receding contact angle is less than 5 degrees.

4. A method as claimed in claim 2 wherein the receding contact angle is zero.

5. A method as claimed in claim 1, wherein the channels are concave.

6. A method as claimed in claim 1 wherein the material is deposited in the deposition region by a printing method.

7. A method as claimed in claim 1 wherein the width of the channel is less than 30 microns.

8. A method as claimed in claim 7 wherein the width of the channel is less than 10 microns.

9. A method as claimed in claim 1 wherein the material is a conductive liquid.

10. A method as claimed in claim 1 wherein the material is made flowable after being deposited in the deposition region.

11. A method as claimed in claim 1 wherein the material is a liquid containing at least one of a polymer, a monomer, a high molecular weight molecule, a latex, a solid particle, an emulsion, a reactive species, a soluble metal complex, biological material.

12. A method as claimed in claim 1 wherein the deposition region forms part of a circuit element after patterning.

13. A device formed, at least in part, by the method according to claim 1.

14. A method of forming the functional elements of a device by use of the method of claim 1.
